(19) United States
(12) Patent Application Publication
(10) Pub. No.: US 2025/0013832 A1
(43) Pub. Date: Jan. 9, 2025

(54) METHOD FOR GENERATING VIDEO DIALOG QUESTION ANSWERING DATA, ELECTRONIC DEVICE, AND MEDIUM

(71) Applicant: BEIJING YOUZHUJU NETWORK TECHNOLOGY CO., LTD., Beijing (CN)

(72) Inventors: Zhengyin DU, Beijing (CN); Hanghang MA, Beijing (CN); Zehuan YUAN, Beijing (CN)

(21) Appl. No.: 18/759,129

(22) Filed: Jun. 28, 2024

(30) Foreign Application Priority Data
Jul. 4, 2023 (CN) 202310813786.8

(51) Int. Cl. G06F 40/35; G06F 40/166; G06F 40/40; G06T 7/70; G06V 20/40; G06V 20/62

(52) U.S. Cl. CPC G06F 40/35; G06F 40/40; G06T 7/70; G06V 20/41; G06V 20/46; G06V 20/635; G06F 40/166; G06T 2207/10016

(57) ABSTRACT

Embodiments of the present disclosure disclose a method and an apparatus for generating video dialog question answering data, an electronic device, and a medium. The method includes: determining target video description information corresponding to a target video; determining a target prompt used for a target question answering model, where the target question answering model is pre-configured based on a large language model, and the target prompt is capable of guiding the target question answering model to a desired dialog question answering effect based on the target video description information when the target question answering model executes a dialog question answering generation task; and outputting, using the target question answering model and based on the target video description information and the target prompt, dialog question answering data associated with the target video.

### CROSS-REFERENCE TO RELATED APPLICATION

The present application claims priority of the Chinese Patent Application No. 202310813786.8, filed on Jul. 4, 2023, the disclosure of which is incorporated herein by reference in the present application.

### TECHNICAL FIELD

Embodiments of the present disclosure relate to the field of video processing technologies, and in particular, to a method and an apparatus for generating video dialog question answering data, an electronic device, and a medium.

### BACKGROUND

With the development of video content understanding, video dialog question answering has become an important technology. Video dialog question answering refers to obtaining an answer to a question by parsing an input video and the question regarding the video.

Video dialog question answering is based on the annotation of video dialog question answering data. Currently, the video dialog question answering data is mainly artificially constructed based on the video. However, the artificial construction of the video dialog question answering data requires watching the entire video before the writing of a description for the video is started, which consumes much time as the video usually lasts from a few minutes to a few hours. In addition, video description is much more difficult and requires some knowledge of a field of video content in order to describe the content of the video accurately, which may lead to poor quality of the constructed video dialog question answering data and have an impact on subsequent video dialog question answering.

### SUMMARY

Embodiments of the present disclosure provide a method and an apparatus for generating video dialog question answering data, an electronic device, and a medium, so as to solve the problem that accurate video dialog question answering data cannot be quickly generated.

According to a first aspect, an embodiment of the present disclosure provides a method for generating video dialog question answering data. The method includes:
determining target video description information corresponding to a target video;
determining a target prompt used for a target question answering model, where the target question answering model is pre-configured based on a large language model, and the target prompt is capable of guiding the target question answering model to a desired dialog question answering effect based on the target video description information when the target question answering model executes a dialog question answering generation task; and
outputting, using the target question answering model and based on the target video description information and the target prompt, dialog question answering data associated with the target video.

According to a second aspect, an embodiment of the present disclosure further provides an apparatus for generating video dialog question answering data. The apparatus includes:
a description information determination module configured to determine target video description information corresponding to a target video;
a prompt information determination module configured to determine a target prompt used for a target question answering model, where the target question answering model is pre-configured based on a large language model, and the target prompt is capable of guiding the target question answering model to a desired dialog question answering effect based on the target video description information when the target question answering model executes a dialog question answering generation task; and
a data generation module configured to output, using the target question answering model and based on the target video description information and the target prompt, dialog question answering data associated with the target video.

According to a third aspect, an embodiment of the present disclosure further provides an electronic device. The electronic device includes:
at least one processor; and
a memory communicatively connected to the at least one processor, where
the memory stores a computer program executable by the at least one processor, and the computer program, when executed by the at least one processor, causes the at least one processor to perform the method for generating video dialog question answering data according to any one of the above embodiments.

According to a fourth aspect, an embodiment of the present disclosure further provides a computer-readable medium, storing computer instructions that, when executed by a processor, cause the method for generating video dialog question answering data according to any one of the above embodiments to be implemented.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a flowchart of a method for generating video dialog question answering data according to an embodiment of the present disclosure;

FIG. 2 is a schematic diagram of applicable display of video dialog question answering data in a display interface according to an embodiment of the present disclosure;

FIG. 3 is a block diagram of a structure of an apparatus for generating video dialog question answering data according to an embodiment of the present disclosure; and

FIG. 4 is a block diagram of a structure of an electronic device that implements a method for generating video dialog question answering data according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from a user, prompt information is sent to the user to clearly inform the user that a requested operation will require access to and use of personal information of the user. As such, the user can independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

Each of the following embodiments provides both optional features and examples. The features described in the embodiment may be combined into a plurality of optional solutions, and each numbered embodiment should not be considered as only one technical solution. In addition, the embodiments in the present disclosure and features in the embodiments can be combined with each other without conflict.

In the technical solution of the embodiments of the present disclosure, the target video description information and the target prompt capable of guiding the target question answering model to the desired dialog question answering effect based on the target video description information when the target question answering model executes the dialog question answering generation task are determined during construction of the video dialog question answering data. In this way, the dialog question answering data can be automatically generated, under the guidance of the target prompt for dialog question answering, based on the target video description information by using the target question answering model pre-configured based on the large language model, so that the problem of a long construction time caused by the fact that the dialog question answering data can be artificially constructed only after a user watches the entire video is solved, allowing real-time construction to be implemented by analyzing the video in real time to obtain the video description information. In addition, the prompt is used in a construction process to guide the question answering model to construct the dialog question answering data, which can ensure the accuracy of the constructed dialog question answering data to a certain extent.

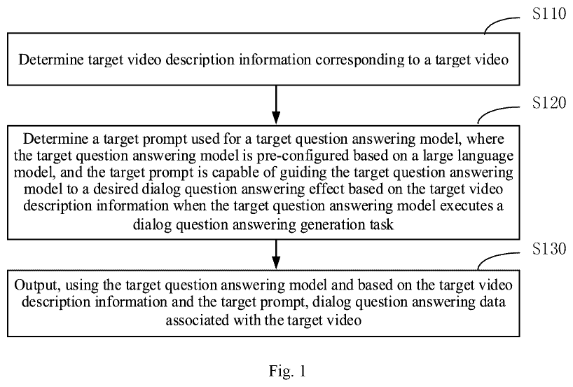

FIG. 1 is a flowchart of a method for generating video dialog question answering data according to an embodiment of the present disclosure. The technical solution of this embodiment is applicable to the use of a video for constructing video dialog question answering data. The method may be performed by an apparatus for generating video dialog question answering data. The apparatus may be implemented by software and/or hardware, and generally integrated into any electronic device having a network communication function. The electronic device includes, but is not limited to, devices such as a computer and a personal digital assistant.

As shown in FIG. 1, the method for generating video dialog question answering data in this embodiment may include the following processes S110 to S130.

S110: Determine target video description information corresponding to a target video.

Video dialog question answering data may be data that is used to conduct a question answering dialog for a video. As videos, particularly short videos, become a way of life for an increasing number of people, understanding of and derivation from content of the videos become increasingly important, e.g., generation of a title, a summary, and a description for a video, and discussion on some topics or details in a video, including discussion on an object, an event, related background knowledge, etc. in the video.

However, during construction of the video dialog question answering data for the video, a user is usually required to watch the entire video before the construction of the video dialog question answering data for the video may be started, resulting in a relatively long time for the construction of the video dialog question answering data. Moreover, an accurate description of content of the video requires certain knowledge of a field to which the content of the video belongs, which further leads to a high difficulty in constructing the video dialog question answering data, and fails to ensure the accuracy of the constructed video dialog question answering data.

In view of this, when video description information is obtained for the target video, according to a preset video description information requirement, video information that meets the requirement can be extracted from the target video through video analysis, so as to obtain the target video description information corresponding to the target video. The target video description information includes a description of a video title, a description of a subject and a local detail event between subjects in a single frame of video picture, a description of a global detail event between subjects expressed sequentially in a plurality of consecutive frames of video pictures, a position of a subject in a video picture, and content of dialog text of the subject in the video picture.

As an optional but non-limiting implementation, the determining target video description information corresponding to a target video may include steps A1 to A3.

Step A1: Detect whether there is a subject appearing in at least two frames of video pictures extracted from the target video, and determine, upon detecting that there is a subject appearing, a position of the subject in the video picture.

Step A2: Determine, upon detecting that there is a subject appearing in the video picture and that a text subtitle appears in the video picture, the appearing text subtitle as content of dialog text of the subject in the video picture.

Step A3: Upon detecting that there is a subject appearing in the video picture and that there is a matching audio in the video picture, convert the matching audio into text, and then determine the text as content of dialog text of the subject in the video picture.

With the above optional manner, the user does not need to watch the entire video, and only needs to import the target video according to the preset video description information requirement, and then the video description information that meets the requirement can be obtained automatically. Then, the obtained video description information is added in time for analysis. With the continuous analysis of the video, new video description information can be continuously added for update. This can greatly reduce the time for obtaining the video description information, and thus reduce the time for constructing the video dialog question answering data. More importantly, the use of automatic video analysis makes it possible to dig out useful content as much as possible, to avoid omissions to some extent, thereby providing more bases for subsequent generation of the dialog question answering data.

S120: Determine a target prompt used for a target question answering model, where the target question answering model is pre-configured based on a large language model, and the target prompt is capable of guiding the target question answering model to a desired dialog question answering effect based on the target video description information when the target question answering model executes a dialog question answering generation task.

As an optional but non-limiting implementation, the target prompt may be configured with first prompt information, second prompt information, third prompt information, fourth prompt information, and fifth prompt information, the first prompt information is used to instruct the target question answering model to simulate watching of the target video to execute the dialog question answering generation task of creating and answering a question, the second prompt information is used to instruct the target question answering model to use details included in the target video description information when the target question answering model executes the dialog question answering generation task, so that an answer fits the target video description information, the third prompt information is used to instruct the target question answering model to give a definite answer when the target question answering model executes the dialog question answering generation task, the fourth prompt information is used to instruct the target question answering model to ask a question of a preset type when the target question answering model executes the dialog question answering generation task, and the fifth prompt information is used to instruct the target question answering model to give an answer including a detailed reasoning process when the target question answering model executes the dialog question answering generation task.

For example, the first prompt information may specifically be a segment of prompt that expects the target question answering model to simulate watching of the target video, so that the target question answering model can execute a question-and-answer dialog question answering task as if the user is watching the target video normally. The second prompt information may specifically be a segment of prompt that expects the target question answering model to use detail content included in the video data description information as much as possible during a question answering process of executing the dialog question answering generation task, to ensure that an answer can better fit actual content of video data. The third prompt information may specifically be a segment of prompt that expects the target question answering model to give a definite answer in combination with details and interactions between characters in the target video when the target question answering model executes the dialog question answering generation task. To be specific, the third prompt information may be a segment of prompt for an answer derived directly or indirectly by reasoning from the target video description information, from which a question may be determined as being absent in the video or unanswerable. The fourth prompt information may specifically be a segment of prompt that expects the target question answering model to give, when executing the dialog question answering generation task, a prompt of a need to ask questions involving temporal perception and reasoning and ask complex questions related to the content of the video. The fifth prompt information may specifically be a segment of prompt that expects the target question answering model to give, when executing the dialog question answering generation task, a prompt of preferentially asking questions about visual changes over time and reasons for these changes or reasons, rather than questions that can be derived by reasoning from a single picture, since a video description is received when the video is watched.

Further, an example of a complete segment of target prompt is given below. As an AI vision assistant, you are watching a video, content of which is provided in descriptions at the end of this specification. According to these descriptions, a task of the AI vision assistant is to answer all questions as if the AI vision assistant is watching the video directly. A dialog is created, in which there are at least three rounds of question answering, the number of rounds of question answering being as large as possible, a person who asks a question is referred to as a “questioner”, and a person who answers the question is referred to as the “AI vision assistant”. In the dialog, it is required to use information included in the video as much as possible. As such, it is ensured that an answer reflects a tone of an AI vision assistant who is actively watching the video and answering questions. The dialog includes various questions and corresponding answers. Questions about visual content of the video such as details of the video content and interactions between characters are incorporated. Each question needs to be given a definite answer. A question for which an answer can be directly observed or indirectly derived by reasoning from the content of the video may be determined as being absent in the video or unanswerable. Next, questions involving temporal perception and reasoning are asked, e.g., by asking what a person did before or after an event, or asking for specific timestamps of some events or actions. Further included are complex questions related to the content of the video, such as asking for background knowledge about an object or action in the video, discussing an event that occurs in the video, delving into a topic that defies facts (e.g., what happens if a person loses his/her mobile phone while playing with the mobile phone in the video), and predicting how a story or scenario in the video will develop. Since a video description is received when the video is watched, questions about visual changes over time and reasons for these changes or reasons are asked preferentially, rather than questions that can be derived by reasoning from a single picture. Remember not to ask for uncertain details. When a complex question is answered, a detailed answer is provided together with detailed examples or reasoning steps, to make content more convincing and structured. A plurality of paragraphs are used if needed. If a question cannot be answered based on a given description, “Such information is not presented in the provided video” is given.

As an optional but non-limiting implementation, the determining a target prompt used for a target question answering model may include the following steps:
determining, in response to a selection operation for the target video, an application scenario of the dialog question answering data corresponding to the target video; and
determining, from candidate prompts associated with the target question answering model, a target prompt matching the application scenario of the dialog question answering data corresponding to the target video.

S130: Output, using the target question answering model and based on the target video description information and the target prompt, dialog question answering data associated with the target video.

As an optional but non-limiting implementation, the outputting, using the target question answering model and based on the target video description information and the target prompt, video dialog question answering data associated with the target video includes the following steps:
adding the target video description information to a preset position indicated by the target prompt, to obtain target input information for the target question answering model;
and controlling, based on the target input information, the target question answering model to execute the dialog question answering generation task, and outputting the video dialog question answering data of the target video based on the execution of the dialog question answering generation task.

For the target prompt similar to that provided above, a video description information field may be configured at the end of the target prompt, and following the video description information field, text content corresponding to the target video description information may be specifically written. Accordingly, the added target video description information is combined with the target prompt to form a complete piece of text content, which is used as the target input information for the target question answering model.

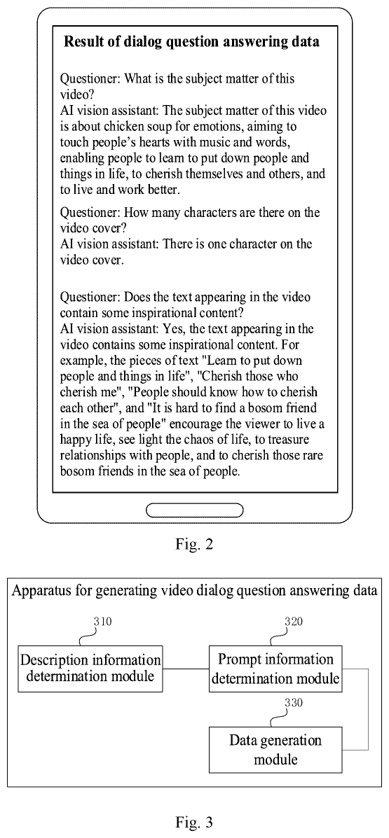

The target input information including the target video description information and the target prompt is input into the target question answering model, such that the target question answering model can understand the target video based on the target video description information and automatically execute the dialog question answering generation task, so as to create a dialog task, in which there are at least three rounds of dialog question answering, forming question-and-answer video dialog question answering data (see FIG. 2, which is a schematic diagram of dialog question answering shown in a question-answering output interface), and the target question answering model can execute the dialog question answering generation task under the guidance of the target prompt.

As an optional but non-limiting implementation, after the outputting, using the target question answering model, dialog question answering data associated with the target video, the method further includes the following steps:
determining, in response to a filter operation for the dialog question answering data associated with the target video, target dialog question answering data from the dialog question answering data associated with the target video; and
adjusting or replacing, in response to an edit operation for the target dialog question answering data, an answer corresponding to a question in the target dialog question answering data, so that an answer obtained through the adjustment or replacement fits the target video description information.

In the above manner, user interaction is introduced in practice to ensure that the output dialog question answering data associated with the target video has both a high-efficiency generation capability of a machine and a fine review capability of the user, so that the quality and diversity of the generated dialog question answering data associated with the target video are achieved. The introduction of the user interaction allows the user to pick or modify text, which not only improves the quality of the dialog question answering data associated with the target video, but also increases the diversity of the generated dialog question answering data associated with the target video.

In the technical solution of this embodiment of the present disclosure, the target video description information and the target prompt capable of guiding the target question answering model to the desired dialog question answering effect based on the target video description information when the target question answering model executes the dialog question answering generation task are determined during construction of the video dialog question answering data. In this way, the dialog question answering data can be automatically generated, under the guidance of the target prompt for dialog question answering, based on the target video description information by using the target question answering model pre-configured based on the large language model, so that the problem of a long construction time caused by the fact that the dialog question answering data can be artificially constructed only after the entire video is watched is solved, allowing real-time construction to be implemented by analyzing the video in real time to obtain the video description information. In addition, the prompt is used in a construction process to guide the question answering model to construct the dialog question answering data, which can ensure the accuracy of the constructed dialog question answering data to a certain extent.

FIG. 3 is a block diagram of a structure of an apparatus for generating video dialog question answering data according to an embodiment of the present disclosure. The technical solution of this embodiment is applicable to the use of a video for constructing video dialog question answering data. The apparatus may be implemented by software and/or hardware, and generally integrated into any electronic device having a network communication function. The electronic device includes, but is not limited to, devices such as a computer and a personal digital assistant.

As shown in FIG. 3, the apparatus for generating video dialog question answering data in this embodiment may include the following modules:
a description information determination module 310 configured to determine target video description information corresponding to a target video;
a prompt information determination module 320 configured to determine a target prompt used for a target question answering model, where the target question answering model is pre-configured based on a large language model, and the target prompt is capable of guiding the target question answering model to a desired dialog question answering effect based on the target video description information when the target question answering model executes a dialog question answering generation task; and
a data generation module 330 configured to output, using the target question answering model and based on the target video description information and the target prompt, dialog question answering data associated with the target video.

Based on the above embodiment, optionally, the video description information includes a description of a video title, a description of a subject and a local detail event between subjects in a single frame of video picture, a description of a global detail event between subjects expressed sequentially in a plurality of consecutive frames of video pictures, a position of a subject in a video picture, and content of dialog text of the subject in the video picture.

Based on the above embodiment, optionally, the determining target video description information corresponding to a target video includes:
detecting whether there is a subject appearing in at least two frames of video pictures extracted from the target video, and determining, upon detecting that there is a subject appearing, a position of the subject in the video picture; and
determining, upon detecting that there is a subject appearing in the video picture and that a text subtitle appears in the video picture, the appearing text subtitle as content of dialog text of the subject in the video picture; and
upon detecting that there is a subject appearing in the video picture and that there is a matching audio in the video picture, converting the matching audio into text, and then determining the text as content of dialog text of the subject in the video picture.

Based on the above embodiment, optionally, the determining a target prompt used for a target question answering model includes:
determining, in response to a select operation for the target video, an application scenario of the dialog question answering data corresponding to the target video; and
determining, from candidate prompts associated with the target question answering model, a target prompt matching the application scenario of the dialog question answering data corresponding to the target video.

Based on the above embodiment, optionally, the outputting, using the target question answering model and based on the target video description information and the target prompt, video dialog question answering data associated with the target video includes:
adding the target video description information to a preset position indicated by the target prompt, to obtain target input information for the target question answering model; and
controlling, based on the target input information, the target question answering model to execute the dialog question answering generation task, and outputting the video dialog question answering data of the target video based on the execution of the dialog question answering generation task.

Based on the above embodiment, optionally, the target prompt is configured with first prompt information, second prompt information, third prompt information, fourth prompt information, and fifth prompt information, the first prompt information is used to instruct the target question answering model to simulate watching of the target video to execute the dialog question answering generation task of creating and answering a question, the second prompt information is used to instruct the target question answering model to use details included in the target video description information when the target question answering model executes the dialog question answering generation task, so that an answer fits the target video description information, the third prompt information is used to instruct the target question answering model to give a definite answer when the target question answering model executes the dialog question answering generation task, the fourth prompt information is used to instruct the target question answering model to ask a question of a preset type when the target question answering model executes the dialog question answering generation task, and the fifth prompt information is used to instruct the target question answering model to give an answer including a detailed reasoning process when the target question answering model executes the dialog question answering generation task.

Based on the above embodiment, optionally, after the outputting, using the target question answering model, dialog question answering data associated with the target video, the following operations are further included:
determining, in response to a filter operation for the dialog question answering data associated with the target video, target dialog question answering data from the dialog question answering data associated with the target video; and
adjusting or replacing, in response to an edit operation for the target dialog question answering data, an answer corresponding to a question in the target dialog question answering data, so that an answer obtained through the adjustment or replacement fits the target video description.

In the technical solution of this embodiment of the present disclosure, the target video description information and the target prompt capable of guiding the target question answering model to the desired dialog question answering effect based on the target video description information when the target question answering model executes the dialog question answering generation task are determined during construction of the video dialog question answering data. In this way, the dialog question answering data can be automatically generated, under the guidance of the target prompt for dialog question answering, based on the target video description information by using the target question answering model pre-configured based on the large language model, so that the problem of a long construction time caused by the fact that the dialog question answering data can be artificially constructed only after the entire video is watched is solved, allowing real-time construction to be implemented by analyzing the video in real time to obtain the video description information. In addition, the prompt is used in a construction process to guide the question answering model to construct the dialog question answering data, which can ensure the accuracy of the constructed dialog question answering data to a certain extent.

The apparatus for generating video dialog question answering data provided in this embodiment of the present disclosure can perform the method for generating video dialog question answering data provided in any one of the embodiments of the present disclosure, and has corresponding functional modules and beneficial effects for performing the method for generating video dialog question answering data.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

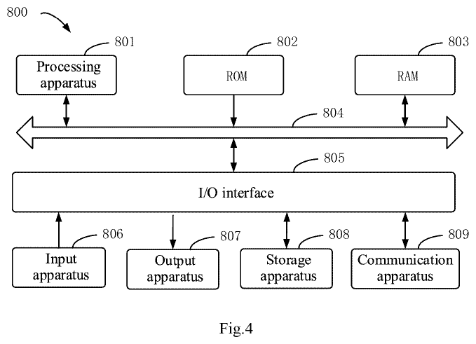

Reference is made to FIG. 4 below, which is a schematic diagram of a structure of an electronic device 800 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 4 is merely an example, and shall not impose any limitation on the function and scope of use of the embodiments of the present disclosure.

As shown in FIG. 4, the electronic device 800 may include a processing apparatus (e.g., a central processing unit, a graphics processing unit, etc.) 801 that may perform a variety of appropriate actions and processing in accordance with a program stored in a read-only memory (ROM) 802 or a program loaded from a storage apparatus 806 into a random access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 806 including, for example, a tape and a hard disk; and a communication apparatus 809. The communication apparatus 809 may allow the electronic device 800 to perform wireless or wired communication with other devices to exchange data. Although FIG. 4 shows the electronic device 800 having various apparatuses, it should be understood that it is not required to implement or have all of the shown apparatuses. It may be an alternative to implement or have more or fewer apparatuses.

The names of messages or information exchanged between a plurality of apparatuses in the implementations of the present disclosure are used for illustrative purposes only, and are not used to limit the scope of these messages or information.

The electronic device provided in this embodiment of the present disclosure and the method for generating video dialog question answering data provided in the above embodiment belong to the same inventive concept. For the technical details not described in detail in this embodiment, reference may be made to the above embodiment, and this embodiment and the above embodiment have the same beneficial effects.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method for generating video dialog question answering data shown in the flowchart. In such an embodiment, the computer program may be downloaded from a network through the communication apparatus 809 and installed, installed from the storage apparatus 806, or installed from the ROM 802. When the computer program is executed by the processing apparatus 801, the above-mentioned functions defined in the method for generating video dialog question answering data in the embodiments of the present disclosure are performed.

An embodiment of the present disclosure provides a computer storage medium having stored thereon a computer program that, when executed by a processor, causes the method for generating video dialog question answering data provided in the above embodiment to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as a HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: determine target video description information corresponding to a target video; determine a target prompt used for a target question answering model, where the target question answering model is pre-configured based on a large language model, and the target prompt is capable of guiding the target question answering model to a desired dialog question answering effect based on the target video description information when the target question answering model executes a dialog question answering generation task; and output, using the target question answering model and based on the target video description information and the target prompt, dialog question answering data associated with the target video.

Alternatively, the above computer-readable medium carries one or more programs that, when executed by the electronic device, cause the electronic device to perform the method for generating video dialog question answering data described in any one of the above embodiments.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and the block diagrams in the accompanying drawings illustrate the possibly implemented architecture, functions, and operations of the system, method, and computer program product according to the embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method for generating video dialog question answering data, the method comprising:
determining target video description information corresponding to a target video;
determining a target prompt used for a target question answering model, wherein the target question answering model is pre-configured based on a large language model, and the target prompt is capable of guiding the target question answering model to a desired dialog question answering effect based on the target video description information when the target question answering model executes a dialog question answering generation task; and
outputting, using the target question answering model and based on the target video description information and the target prompt, dialog question answering data associated with the target video.

2. The method according to claim 1, wherein the video description information comprises a description of a video title, a description of a subject and a local detail event between subjects in a single frame of video picture, a description of a global detail event between subjects expressed sequentially in a plurality of consecutive frames of video pictures, a position of a subject in a video picture, and content of dialog text of the subject in the video picture.

3. The method according to claim 2, wherein the determining target video description information corresponding to a target video comprises:
detecting whether there is a subject appearing in at least two frames of video pictures extracted from the target video, and determining, upon detecting that there is a subject appearing, a position of the subject in the video picture; and
determining, upon detecting that there is a subject appearing in the video picture and that a text subtitle appears in the video picture, the appearing text subtitle as content of dialog text of the subject in the video picture; and
upon detecting that there is a subject appearing in the video picture and that there is a matching audio in the video picture, converting the matching audio into text, and then determining the text as content of dialog text of the subject in the video picture.

4. The method according to claim 1, wherein the determining a target prompt used for a target question answering model comprises:
determining, in response to a select operation for the target video, an application scenario of the dialog question answering data corresponding to the target video; and
determining, from candidate prompts associated with the target question answering model, a target prompt matching the application scenario of the dialog question answering data corresponding to the target video.

5. The method according to claim 1, wherein the outputting, using the target question answering model and based on the target video description information and the target prompt, video dialog question answering data associated with the target video comprises:
adding the target video description information to a preset position indicated by the target prompt, to obtain target input information for the target question answering model; and
controlling, based on the target input information, the target question answering model to execute the dialog question answering generation task, and outputting the video dialog question answering data of the target video based on the execution of the dialog question answering generation task.

6. The method according to claim 1, wherein the target prompt is configured with first prompt information, second prompt information, third prompt information, fourth prompt information, and fifth prompt information, the first prompt information is used to instruct the target question answering model to simulate watching of the target video to execute the dialog question answering generation task of creating and answering a question, the second prompt information is used to instruct the target question answering model to use details comprised in the target video description information when the target question answering model executes the dialog question answering generation task, so that an answer fits the target video description information, the third prompt information is used to instruct the target question answering model to give a definite answer when the target question answering model executes the dialog question answering generation task, the fourth prompt information is used to instruct the target question answering model to ask a question of a preset type when the target question answering model executes the dialog question answering generation task, and the fifth prompt information is used to instruct the target question answering model to give an answer comprising a detailed reasoning process when the target question answering model executes the dialog question answering generation task.

7. The method according to claim 1, wherein after the outputting, using the target question answering model, dialog question answering data associated with the target video, the method further comprises:
determining, in response to a filter operation for the dialog question answering data associated with the target video, target dialog question answering data from the dialog question answering data associated with the target video; and
adjusting or replacing, in response to an edit operation for the target dialog question answering data, an answer corresponding to a question in the target dialog question answering data, so that an answer obtained through the adjustment or replacement fits the target video description.

8. An electronic device, comprising:
at least one processor; and
a memory communicatively connected to the at least one processor, wherein
the memory stores a computer program executable by the at least one processor, and the computer program, when executed by the at least one processor, causes the at least one processor to perform a method for generating video dialog question answering data, which comprises:
determining target video description information corresponding to a target video;
determining a target prompt used for a target question answering model, wherein the target question answering model is pre-configured based on a large language model, and the target prompt is capable of guiding the target question answering model to a desired dialog question answering effect based on the target video description information when the target question answering model executes a dialog question answering generation task; and
outputting, using the target question answering model and based on the target video description information and the target prompt, dialog question answering data associated with the target video.

9. The electronic device according to claim 8, wherein the video description information comprises a description of a video title, a description of a subject and a local detail event between subjects in a single frame of video picture, a description of a global detail event between subjects expressed sequentially in a plurality of consecutive frames of video pictures, a position of a subject in a video picture, and content of dialog text of the subject in the video picture.

10. The electronic device according to claim 9, wherein the determining target video description information corresponding to a target video comprises:
detecting whether there is a subject appearing in at least two frames of video pictures extracted from the target video, and determining, upon detecting that there is a subject appearing, a position of the subject in the video picture; and
determining, upon detecting that there is a subject appearing in the video picture and that a text subtitle appears in the video picture, the appearing text subtitle as content of dialog text of the subject in the video picture; and
upon detecting that there is a subject appearing in the video picture and that there is a matching audio in the video picture, converting the matching audio into text, and then determining the text as content of dialog text of the subject in the video picture.

11. The electronic device according to claim 8, wherein the determining a target prompt used for a target question answering model comprises:
determining, in response to a select operation for the target video, an application scenario of the dialog question answering data corresponding to the target video; and
determining, from candidate prompts associated with the target question answering model, a target prompt matching the application scenario of the dialog question answering data corresponding to the target video.

12. The electronic device according to claim 8, wherein the outputting, using the target question answering model and based on the target video description information and the target prompt, video dialog question answering data associated with the target video comprises:
adding the target video description information to a preset position indicated by the target prompt, to obtain target input information for the target question answering model; and
controlling, based on the target input information, the target question answering model to execute the dialog question answering generation task, and outputting the video dialog question answering data of the target video based on the execution of the dialog question answering generation task.

13. The electronic device according to claim 8, wherein the target prompt is configured with first prompt information, second prompt information, third prompt information, fourth prompt information, and fifth prompt information, the first prompt information is used to instruct the target question answering model to simulate watching of the target video to execute the dialog question answering generation task of creating and answering a question, the second prompt information is used to instruct the target question answering model to use details comprised in the target video description information when the target question answering model executes the dialog question answering generation task, so that an answer fits the target video description information, the third prompt information is used to instruct the target question answering model to give a definite answer when the target question answering model executes the dialog question answering generation task, the fourth prompt information is used to instruct the target question answering model to ask a question of a preset type when the target question answering model executes the dialog question answering generation task, and the fifth prompt information is used to instruct the target question answering model to give an answer comprising a detailed reasoning process when the target question answering model executes the dialog question answering generation task.

14. The electronic device according to claim 8, wherein after the outputting, using the target question answering model, dialog question answering data associated with the target video, the method further comprises:
determining, in response to a filter operation for the dialog question answering data associated with the target video, target dialog question answering data from the dialog question answering data associated with the target video; and
adjusting or replacing, in response to an edit operation for the target dialog question answering data, an answer corresponding to a question in the target dialog question answering data, so that an answer obtained through the adjustment or replacement fits the target video description.

15. A non-transitory computer-readable medium, storing computer instructions that, when executed by a processor, cause a method for generating video dialog question answering data to be implemented, and the method comprises:
determining target video description information corresponding to a target video;
determining a target prompt used for a target question answering model, wherein the target question answering model is pre-configured based on a large language model, and the target prompt is capable of guiding the target question answering model to a desired dialog question answering effect based on the target video description information when the target question answering model executes a dialog question answering generation task; and
outputting, using the target question answering model and based on the target video description information and the target prompt, dialog question answering data associated with the target video.

16. The non-transitory computer-readable medium according to claim 15, wherein the video description information comprises a description of a video title, a description of a subject and a local detail event between subjects in a single frame of video picture, a description of a global detail event between subjects expressed sequentially in a plurality of consecutive frames of video pictures, a position of a subject in a video picture, and content of dialog text of the subject in the video picture.

17. The non-transitory computer-readable medium according to claim 16, wherein the determining target video description information corresponding to a target video comprises:
detecting whether there is a subject appearing in at least two frames of video pictures extracted from the target video, and determining, upon detecting that there is a subject appearing, a position of the subject in the video picture; and
determining, upon detecting that there is a subject appearing in the video picture and that a text subtitle appears in the video picture, the appearing text subtitle as content of dialog text of the subject in the video picture; and
upon detecting that there is a subject appearing in the video picture and that there is a matching audio in the video picture, converting the matching audio into text, and then determining the text as content of dialog text of the subject in the video picture.

18. The non-transitory computer-readable medium according to claim 15, wherein the determining a target prompt used for a target question answering model comprises:
determining, in response to a select operation for the target video, an application scenario of the dialog question answering data corresponding to the target video; and
determining, from candidate prompts associated with the target question answering model, a target prompt matching the application scenario of the dialog question answering data corresponding to the target video.

19. The non-transitory computer-readable medium according to claim 15, wherein the outputting, using the target question answering model and based on the target video description information and the target prompt, video dialog question answering data associated with the target video comprises:
adding the target video description information to a preset position indicated by the target prompt, to obtain target input information for the target question answering model; and
controlling, based on the target input information, the target question answering model to execute the dialog question answering generation task, and outputting the video dialog question answering data of the target video based on the execution of the dialog question answering generation task.

20. The non-transitory computer-readable medium according to claim 15, wherein the target prompt is configured with first prompt information, second prompt information, third prompt information, fourth prompt information, and fifth prompt information, the first prompt information is used to instruct the target question answering model to simulate watching of the target video to execute the dialog question answering generation task of creating and answering a question, the second prompt information is used to instruct the target question answering model to use details comprised in the target video description information when the target question answering model executes the dialog question answering generation task, so that an answer fits the target video description information, the third prompt information is used to instruct the target question answering model to give a definite answer when the target question answering model executes the dialog question answering generation task, the fourth prompt information is used to instruct the target question answering model to ask a question of a preset type when the target question answering model executes the dialog question answering generation task, and the fifth prompt information is used to instruct the target question answering model to give an answer comprising a detailed reasoning process when the target question answering model executes the dialog question answering generation task.
